(19) United States
(12) Patent Application Publication
(10) Pub. No.: US 2024/0027224 A1
(43) Pub. Date: Jan. 25, 2024

(54) METHOD FOR RECOGNIZING AN ERRONEOUS MAP OF AN ENVIRONMENT

(71) Applicant: Robert Bosch GmbH, Stuttgart (DE)

(72) Inventors: Gerhard Kurz, Karlsruhe (DE); Matthias Holoch, Leonberg (DE)

(21) Appl. No.: 18/351,757

(22) Filed: Jul. 13, 2023

(30) Foreign Application Priority Data
Jul. 19, 2022 (DE) 10 2022 207 370.3

(51) Int. Cl. G01C 21/00; G01C 21/32

(52) U.S. Cl. CPC G01C 21/3833; G01C 21/387; G01C 21/32

(57) ABSTRACT

A method for recognizing an erroneous map of an environment. The map being obtained by merging a first map and a second map which are based on a SLAM graph and on data sets with information about the environment. The method includes: providing an updated second map obtained by merging the first map and the second map and updated after the merge; determining whether the updated second map is erroneous, including: performing a comparison of first map data of the first map from the first acquisition period to second map data from the second acquisition period, determining a degree of matching between the second map data and the first map data, determining that the updated second map is erroneous if the degree of matching fulfills a specified criterion; and providing, if it has been determined that the updated second map is erroneous, information that the map is erroneous.

### CROSS REFERENCE

The present application claims the benefit under 35 U.S.C. § 119 of German Patent Application No. DE 10 2022 207 370.3 filed on Jul. 19, 2022, which is expressly incorporated herein by reference in its entirety.

### FIELD

The present invention relates to a method for recognizing an erroneous map of an environment, which map has been obtained by merging at least two maps, and to a system for data processing, a mobile device, and a computer program for performing the same.

### BACKGROUND INFORMATION

Mobile devices, such as vehicles or robots moving in an at least partially automated manner, typically move in an environment, in particular in an environment to be processed or in a work area, such as an apartment, in a garden, in a factory hall, or on the road, in air or in water. One of the basic problems of such or also other mobile devices is orienting, i.e., knowing what the environment looks like, i.e., in particular where obstacles or other objects are, and where (in absolute terms) the mobile device is. For this purpose, the mobile device can, for example, be equipped with various sensors, such as cameras, lidar sensors or inertial sensors, with the help of which the environment and the movement of the mobile device are, for example, sensed two- or three-dimensionally. This allows the mobile device to move locally, to recognize obstacles in a timely manner and to drive around them.

In addition, if the absolute position of the mobile device is known, e.g., from additional GPS sensors, a map can be constructed. In so doing, the mobile device measures the relative position of possible obstacles to it and, with its known position, can then determine the absolute position of the obstacles, which are subsequently entered into the map. However, this only works with position information provided externally.

SLAM (“Simultaneous Localization and Mapping”) refers to a method in robotics in which a mobile device, such as a robot, can or must simultaneously create a map of its environment and estimate its spatial location within this map. It is thus used to recognize obstacles and thus supports autonomous navigation.

### SUMMARY

According to the present invention, a method for recognizing an erroneous map as well as a system for data processing, a mobile device and a computer program for performing said method are provided. Advantageous embodiments of the present invention are disclosed herein.

The present invention deals with the topic of SLAM as well as in particular its application for mobile devices. Examples of such mobile devices (or even mobile equipment) are, for example, robots and/or drones and/or also vehicles moving in a semi-automated or (fully) automated manner (by land, water, or in air). Household robots, such as robotic vacuum cleaners and/or mopping robots, ground or road cleaning devices or robotic mowers, come into consideration as robots, but so do other so-called service robots, as vehicles moving in an at least partially automated manner, e.g., passenger transport vehicles or goods transport vehicles (also so-called forklifts, for example in warehouses), but also aircraft, such as so-called drones, or watercraft.

In particular, such a mobile device comprises a control or regulating unit and a drive unit for moving the mobile device so that the mobile device can be moved in the environment and, for example, along a trajectory. Moreover, a mobile device comprises, for example, one or more sensors by means of which information in the environment and/or of objects (in the environment, in particular obstacles) and/or of the mobile device itself can be sensed. Examples of such sensors are lidar sensors or other sensors for determining distances, cameras, and inertial sensors. By means of a lidar sensor, so-called point clouds can, for example, be sensed or obtained. Likewise, a so-called odometry (of the mobile device) can be taken into account, for example.

With SLAM, there are different approaches to representing maps and positions. Conventional methods for SLAM are generally based on geometrical information, such as nodes and edges. Nodes and edges are typically components of the SLAM graph. The nodes and edges in the SLAM graph may be designed in different ways; traditionally, the nodes correspond, for example, to the pose (position and orientation) of the mobile device or particular environmental features at particular points in time, while the edges represent relative measurements between the mobile device and the environmental feature. SLAM graphs are described in more detail in, for example, Giorgio Grisetti, Rainer Kümmerle, Cyrill Stachniss, Wolfram Burgard, “A Tutorial on Graph-Based SLAM,” IEEE Intelligent Transportation Systems Magazine, Vol. 2(4), pp 31-42, 2010.

According to an example embodiment of the present invention, a map of the environment in which the mobile device is moving may have been determined or may be determined based on such a SLAM graph. With each new data set with information about the environment, which information is obtained from a sensor of the mobile device or is based thereon, the map (or the SLAM graph) may be expanded or updated. A further aspect of SLAM in this context is so-called “lifelong SLAM,” wherein SLAM is to be used in an environment in the long term. A problem of relocalization may occur therein. If a robot or mobile device is switched on in an unknown location or if the localization is temporarily lost (e.g., because sensors are obscured, the robot is moved by a person, etc.), the robot must again be located relative to an existing map.

According to an example embodiment of the present invention, one way to implement this is to first start a new empty map (with a correspondingly underlying SLAM graph) and to later merge this map with an existing map (likewise with a correspondingly underlying SLAM graph) by, for example, determining the position and/or orientation (pose) of the robot in the existing map, transforming the map accordingly, and adding the information thereof into the current map. Generally, a first and a second map are thus merged, for which purpose at least a portion of the first (e.g., former) map is, for example, transferred or integrated into the second (e.g., current) map. A new map or an updated or expanded second map is produced.

It is desirable that this merging takes place as soon as possible so that information from the existing map can be used again. This is, for example, expedient for a robot vacuum cleaner to (again) know where vacuuming has already taken place and where not.

When merging two maps (or the underlying SLAM graphs and/or the data sets of the maps), it may happen that incorrect merges occur, i.e., that the pose of the robot in the existing map is not correct, e.g., due to “perceptual aliasing,” i.e., different parts of the environment look similar so that they can easily be confused. An erroneous map is produced. Incorrect merges can degrade the map of the robot or even render it useless. Further operation of the robot without intervention by the user is then no longer possible.

The risk of incorrect merges or of erroneous maps produced thereby can now basically be reduced by waiting longer before a merge in order to gather additional information and performing merges only if the likelihood of an incorrect merge is low enough. However, in this way, correct merges are also delayed or even prevented completely, which results in information from the existing map being usable only later or not at all. Such information may, for example, be the pose of the base/charging station (or docking station), navigational destinations, no-go zones (prohibited areas), areas that have already been cleaned or are still to be cleaned, etc. Since this information is usually essential for the robot to carry out its mission, a correct merge as early as possible is of great importance.

In light of this, according to an example embodiment of the present invention, a possibility is provided of recognizing an erroneous map of an environment, which map has been obtained by merging a first map and a second map, i.e., recognizing an incorrect merge of two maps. This makes it possible to subsequently recognize and rectify incorrect merges. It is thus possible to perform even still uncertain merges very early and to take a higher risk in the merge since an incorrect merge can generally be reversed again shortly thereafter.

A merge as used in the context of the present invention takes place by transferring at least a portion of the first map (but preferably the entire first map) into the second map. Each of the maps (i.e., the first and the second as well as the new or updated second map) was based in each case on a SLAM graph and on data sets with information about the environment, which information has been obtained from a sensor of the mobile device. In general, for example, a map that is currently being used (the second map) can always be active, and one or more former maps can be inactive and, for example, saved. After a relocalization, a new map can always be started, which is then the active map. During a merge, an inactive map can then be integrated into the active map. Of course, the (first) map to be integrated may itself have resulted from a merge.

In order to be able to distinguish between the maps and in particular their map data (data sets and SLAM graphs or their nodes) before and after relocalization or merging, a new identifier or ID can be assigned, with each new start of a map, to all data then generated. Generally, a distinction can be made between acquisition periods, a first acquisition period for the first map (which ends upon merging) and a second acquisition period for the second map, which however continues upon merging. When merging the first and second maps, one or more loop closures may possibly also be generated, which are inserted for the second map.

More information on how hypotheses can, for example, be generated, with which relative pose the maps can be merged, is described, for example, in D. Fontanelli, L. Ricciato, and S. Soatto, “A fast RANSAC-based registration algorithm for accurate localization in unknown environments using LIDAR measurements,” in 2007 IEEE International Conference on Automation Science and Engineering. IEEE, September 2007, in T. Schmiedel, E. Einhorn, and H.-M. Gross, “Iron: A fast interest point descriptor for robust ndt-map matching and its application to robot localization,” in 2015 IEEE/RSJ International Conference on Intelligent Robots and Systems (IROS). IEEE, 2015, pp. 3144-3151 and in G. D. Tipaldi and K. O. Arras, “FLIRT—interest regions for 2d range data,” in 2010 IEEE International Conference on Robotics and Automation. IEEE, May 2010.

In order to now recognize an erroneous map after merging or recognize an incorrect or erroneous merge, an updated second map is considered or provided, viz., one that has been obtained by merging the first map and the second map and that has (moreover already) been updated after the merge, in particular based on at least one new data set (e.g., as a result of a new lidar scan) and/or a new node of the SLAM graph (e.g., generated based on a new lidar scan).

According to an example embodiment of the present invention, in order to determine whether the updated second map is erroneous, a comparison of first map data of the first map from the first acquisition period to second map data from the second acquisition period is performed. Here, a degree of matching between the second map data and the first map data is then determined. If the degree of matching fulfills at least one specified criterion, i.e., if, for example, a number of contradicting data sets between the first and second acquisition periods is more than a threshold value or, conversely, if a number of matching data sets is less than a threshold value, it is determined that the updated second map is erroneous. Information in this respect is then provided if the updated second map is erroneous. In particular, the portion transferred from the first map into the second map, in particular nodes and/or edges of the SLAM graph, is then at least partially removed again. This works in particular due to the mentioned different acquisition periods and the identifier or ID assigned therefor.

An erroneous map is recognized in particular due to the recognition of an unexpected appearance in the environment, e.g., by methods that can predict the map quality or quality or differences in maps. An erroneous map can result in various locations overlapping in the merged map. This results, for example, in walls that intersect at unusual angles and can often be easily recognized by a person as a “broken map.” In this case, it is not necessary to recognize a location, e.g., in the manner of “This is location C so it cannot be location B.” Instead, the assessment “this is not location B” is sufficient.

One advantage of this type of recognition is that it can work with local information about the current location of the robot. In contrast, when searching for a better hypothesis—a different way of recognizing erroneous maps that will be discussed later—each new bit of sensor data must be compared to all known locations. For this purpose, a or any algorithm that is capable of first finding a merge may basically be used. However, parallel use of both types of recognition is likewise expedient and provides better results at possibly somewhat higher runtime costs.

According to an example embodiment of the present invention, when recognizing an unexpected occurrence, two different types can again be distinguished. Preferably, performing the comparison first comprises forming one or more pairs of, in each case, a data set of the first and of the second map data. For the one or each of the plurality of pairs, it is then determined, for each of at least some, preferably all, points of the one or more data sets of the first or the second map data, whether or not the point matches a point of the respectively other data set of the pair. The degree of matching is then determined based on a first number of points that match a point of the respectively other data set of the pair and a second number of points that do not match a point of the respectively other data set of the pair.

Specifically, this can be based on the method from J. P. Underwood, D. Gillsjö, T. Bailey, and V. Vlaskine, “Explicit 3D change detection using ray-tracing in spherical coordinates,” in Proc. IEEE Int. Conf. Robotics and Automation, 2013, pp. 4735-4741 in order to, for example, detect changes in 2D or 3D point clouds (e.g., from lidar scans). The method works with a pair of scans (data sets) (D^{t},D^{s}). Each scan consists of D^{a}=(x^{a},S^{a}) where x^{a} is the global 6D position of the scan and S^{a} is the set of the endpoints in spherical (3D scans) or polar (2D scans) coordinates. The algorithm returns a subset of point indices C^{t}={i₁, . . . , i_{M}}, i∈{1, . . . , |D^{t}|} that violate the free space of D^{s}. If (D^{t},D^{s}) are correctly aligned, the points in D^{t} most likely represent dynamic or semistatic objects. However, a misalignment of (D^{t},D^{s}) can also result in a variety of free space violations, e.g., as a result of intersecting wall segments. This fact can be used to recognize invalid or erroneous merges.

The mentioned algorithm is now expediently adapted to additionally distinguish whether a measurement in D^{t} matches how D^{s} has perceived the environment, or whether D^{s} has no information about this part of the environment. For this purpose, the range check (see algorithm 1, line 4 in J. P. Underwood, D. Gillsjö, T. Bailey, and V. Vlaskine, “Explicit 3D change detection using ray-tracing in spherical coordinates,” in Proc. IEEE Int. Conf. Robotics and Automation, 2013, pp. 4735-4741”) can be adapted to return a list of class names, with

$${c}^{p} = \{ \begin{matrix}change , & {r}^{t} < {r}_{min}^{s} + {T}_{r} \\ agree , & {r}^{t} ∈ [ {r}_{min}^{s} - {T}_{r} , {r}_{max}^{s} + {T}_{r} ] ∧ {r}_{min}^{s} + {r}_{max}^{s} \leq 2 \cdot {T}_{r} \\ no info , & else\end{matrix}$$

The value depends on the minimum (min) and maximum (max) range rₘᵢₙ^{s} and rₘₐₓ^{s} of closely adjacent points from Sₙₑₐᵣ^{s}⊂S^{s}.

The interval of agreement (“agree”) may become large if S^{s} includes objects at a steep angle or at object boundaries. In order to solve this problem, it can additionally be checked that this interval is smaller than 2·Tᵣ. For example, Tᵣ=0.1 m and T_{α}=3° may be used. In an alternatively preferred approach, for example, instead of calculating the minimum and maximum, it can be checked whether the considered point is near any point in the neighborhood, i.e., whether a distance difference is less than a threshold value. If this is the case, “agree” is output. Each time a new scan Dⁱ (or, in general, a data set) is added to a map after the merge, the most recent (latest) n scans of the second acquisition period are, for example, used to form pairs of data sets or scans, as mentioned. For example, each of these scans is paired with all scans from the first acquisition period. In so doing, only data sets that overlap the data sets of the second map data at least by a specified amount are preferably used for the first map data.

For this purpose, according to an example embodiment of the present invention, a visibility grid in which each cell contains the identifiers of all scans from the first acquisition period they observed may be used, for example. Since the grid does not contain any data from the active (second) acquisition period, it is sufficient to calculate the grid once after the merge. This algorithm is then, in particular, applied symmetrically to all pairs of data sets or scans. Each point thus receives a plurality of classifications (“agree,” i.e., match, or “change”), one for each pair in which it is contained.

According to an example embodiment of the present invention, it is also preferred if a respectively new updated second map is repeatedly provided, which are respectively updated again in relation to a previous updated second map, wherein the comparison is then in each case performed again with the new updated second maps. New class names c^{p} can then additionally be received over time if new scans or data sets are entered into the map. For each point, the class names c^{p} can then be fused according to the following scheme, for example:

$${c}_{fused}^{p} = \{ \begin{matrix}agree , & {c}_{fused}^{p} = agree ∨ {c}_{new}^{p} = agree \\ no info , & {c}_{fused}^{p} = no info ∧ {c}_{new}^{p} = no info \\ change , & else\end{matrix}$$

This scheme prioritizes the class “agree” over the class “change” in order to become more robust, e.g., against obstacles that appear transparent to the lidar. The fused class names may be stored in the cache, for example. However, if the estimated pose of a node has changed significantly during graph optimization, for example due to loop closures, the cache will be rendered invalid and the classifications will be performed again if the node is still relevant to recognizing an erroneous merge.

It can then be counted how often the different classes or class names for all items considered occur. The value can then be

$${r}_{invalid} = \frac{{C}^{change}}{{C}^{agree} + {C}^{change}}$$

determined as a degree of matching with the first number C^{agree} of points that match a point of the respectively other data set of the pair and a second number C^{change} of points that do not match a point of the respectively other data set of the pair. If the value r_{invalid} is then, for example, greater than a correspondingly selected threshold value (as a criterion), an erroneous map can be recognized (i.e., it is determined that the map is erroneous).

If it is not determined that the updated second map is erroneous, a new updated second map can be provided, which is updated again in relation to a previous updated second map; it can then be determined whether the new updated second map is erroneous. This can take place until either an erroneous map has been recognized or else a termination criterion is present, e.g., a certain amount of time has elapsed.

According to an example embodiment of the present invention, when recognizing the unexpected occurrence, another type of recognition may also be used, based on a grid map. Performing the comparison here then, in particular, comprises determining, based on second map data, a map detail of the updated second map. This may, for example, take place based on one or more, preferably latest, data sets or scans (e.g., in the case of lidar, also referred to as key frames) through which a certain map detail is defined. Then, a grid, in particular a regular grid, with cells for the map detail is determined. For this purpose, an axis-aligned bounding box of all scans determined with these key frames can, for example, be used. This bounding box corresponds to the area of interest, i.e., the map detail. For example, the edge length of a cell may be 2.5 cm.

For each of at least some, preferably all, cells of the grid, it is then determined whether a second node of a SLAM graph from the second (current) acquisition period is located in the respective cell, and whether a first node of a SLAM graph from the first (former) acquisition period is located in the respective cell. The degree of matching is then determined based on a first number of cells in which first and second nodes are located and a second number in which only a first or only a second node is located.

Each cell may then take three possible states for each of the two acquisition periods: “empty” (i.e., no node in the cell), “occupied” (i.e., at least one node in the cell), and “unknown.” For the first acquisition period with a and the second acquisition period with b, for example, this results, in the first number Cₒᵥₑᵣₗₐₚ and the second number C_{contradiction} as follows:

Cₒᵥₑᵣₗₐₚ={¬a is unknown ∧¬b is unknown}

C_{contradiction}={(a is empty∧b is occupied)∨(a is occupied∧b is empty)}

A value can then be determined as a degree of matching as follows:

$$r = \{ \begin{matrix}\vert {C}_{overlap} \vert \geq r , & \frac{\vert {C}_{contradiction} \vert}{\vert {C}_{overlap} \vert} \\ \vert {C}_{overlap} \vert < r , & 0\end{matrix}$$

A larger r means more contradictions and thus a higher likelihood that an invalid merge has taken place. Since occupied areas in the map, such as walls, are usually relatively thin, even a slight shift by a single cell results in a contradiction. A convolution operation (with a square structural element of, for example, seven times seven cells) can therefore be applied to both grids (or the one grid for each acquisition period) before they are compared, in order to increase the size of the occupied areas.

As mentioned, recognition can also take place by searching for a better hypothesis. Both types of recognition can be used in parallel, but it is possible for the type with the better hypothesis to also be used alone. In this case, determining whether the updated second map is erroneous comprises determining a further (or another) degree of matching between the updated second map, to the extent that it is based on map data from the second acquisition period, and the first map. The further degree of matching is then compared to a corresponding degree of matching from before the merge. It is then determined that the updated second map is erroneous if the further degree of matching fulfills at least one specified criterion.

This approach finds (or searches for) a better hypothesis of how two maps can be merged using location recognition. Assuming that the same location is recorded in both maps. If a merge is correct, this location should be at a single location on the merged map. On the other hand, with an incorrectly merged map, a (real) location may exist at two different (hypothetical) locations.

A system according to the present invention for data processing, e.g., a control unit of a robot, of a drone, of a vehicle, etc., is configured, in particular in terms of program technology, to perform a method according to the present invention.

Although it is particularly advantageous to carry out the mentioned method steps in the computing or control unit in the mobile device, some or all method steps may also be performed on another computing unit or a computer, such as a server (keyword: cloud); for this purpose, a preferably wireless data or communication link between the computing units is accordingly required. There is thus a computing system for performing the method steps.

The present invention also relates to a mobile device configured to obtain navigation information as mentioned above and to navigate based on navigation information. This may, for example, be a passenger transport vehicle or goods transport vehicle, a robot, in particular a household robot, e.g., a robotic vacuum cleaner and/or mopping robot, a ground or road cleaning device or robotic mower, a drone, or even combinations thereof. Furthermore, the mobile device may comprise one or more sensors for sensing object and/or environmental information. Moreover, the mobile device may in particular comprise a control or regulating unit and a drive unit for moving the mobile device.

The implementation of a method according to the present invention in the form of a computer program or computer program product with program code for performing all method steps is also advantageous since this results in particularly low costs, in particular if an executing control device is also used for further tasks and is therefore present in any event. Lastly, a machine-readable storage medium is provided, on which as computer program as described above is stored. Suitable storage media or data carriers for providing the computer program are in particular magnetic, optical and electrical memories, such as hard disks, flash memories, EEPROMs, DVDs, etc. Downloading a program via computer networks (internet, intranet, etc.) is also possible. Such a download can take place in a wired or cabled or wireless manner (e.g., via a WLAN, a 3G, 4G, 5G, or 6G connection, etc.).

Further advantages and embodiments of the present invention emerge from the description and the figures.

The present invention is illustrated schematically in the drawing on the basis of exemplary embodiments and is described below with reference to the figures.

### BRIEF DESCRIPTION OF THE DRAWINGS

FIG. 1 schematically shows a mobile device in an environment for explaining the present invention in a preferred embodiment.

FIG. 2A schematically shows map for explaining the present invention in a preferred embodiment.

FIG. 2B schematically shows map for explaining the present invention in a preferred embodiment.

FIG. 2C schematically shows map for explaining the present invention in a preferred embodiment.

FIG. 2D schematically shows map for explaining the present invention in a preferred embodiment.

FIG. 2E schematically shows map for explaining the present invention in a preferred embodiment.

FIG. 2F schematically shows map for explaining the present invention in a preferred embodiment.

FIG. 3 schematically shows a sequence of a method according to the present invention in a preferred embodiment.

FIG. 4A shows an example of visibility of a long wall and two short walls according to the present invention in a preferred embodiment.

FIG. 4B shows exemplary beams for lidar scans according to the present invention in a preferred embodiment.

### DETAILED DESCRIPTION OF EXAMPLE EMBODIMENTS

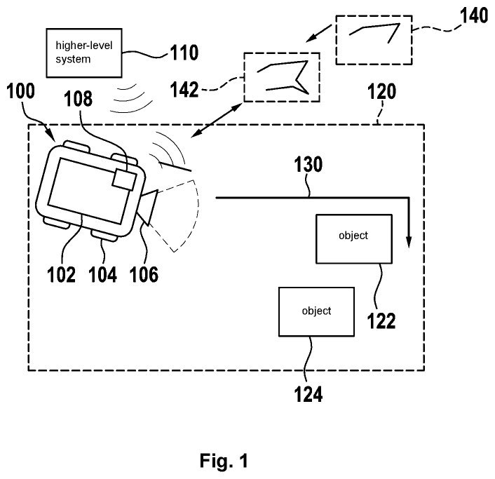

FIG. 1 schematically and purely by way of example shows a mobile device 100 in an environment 120 for explaining the present invention. The mobile device 100 may, for example, be a robot, such as a robotic vacuum cleaner or robotic mower, with a control or regulating unit 102 and a drive unit 104 (with wheels) for moving the robot 100, e.g., along a trajectory 130. As mentioned, it may however also be another type of mobile device, e.g., a goods transport vehicle.

Furthermore, the robot 100, by way of example, comprises a sensor 106 designed as a lidar sensor with a detection field (indicated with dashes). For better illustration, the detection field is selected here to be relatively small; in practice, the detection field may however also be up to 360° (however, e.g., at least 180° or at least 270°). By means of the lidar sensor 106, object and/or environmental information, such as distances of objects, can be sensed. By way of example, two objects 122 and 124 are shown. Moreover, the robot may, for example, comprise a camera in addition to or instead of the lidar sensor.

Also schematically indicated is a map 142, which is based on a SLAM graph and which the mobile device 100 can use to navigate. The map 140 includes, for example, the objects 122, 124 as anchor points with a suitable description after they have been added. The map 142 is a second map obtained by merging a first map 140 from a first acquisition period and the second map, with which a second acquisition period starts, by transferring at least a portion of the first map 140 into the second map 142. The second map 142 is then currently continued and used for navigation.

Furthermore, the robot 100 comprises a system 108 for data processing, e.g., a control device, by means of which data can be exchanged with a higher-level system 110 for data processing via an indicated radio link, for example. In the system 110 (e.g., a server, but it may also refer to a so-called cloud), navigation information, for example comprising the trajectory 130, can be determined from, for example, the map 142 or its SLAM graphs, which navigation information is then transmitted to the system 108 In the robot 100, based on which the robot is then to navigate. However, it may likewise be provided that navigation information is determined in the system 108 itself or otherwise obtained there. Instead of navigation information, the system 108 may however also obtain, for example, control information which has been determined on the basis of the navigation information and according to which the control or regulating unit 102 can move the robot 100 via the drive unit 104 in order to, for example, follow the trajectory 130.

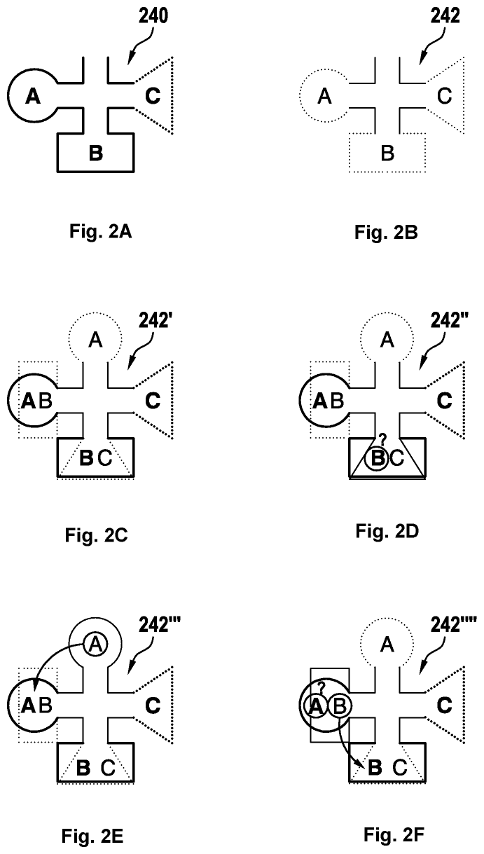

FIG. 2 schematically shows maps for explaining the present invention in a preferred embodiment. As mentioned, two maps can be merged by transferring at least a portion of the first map into the second map. Representation (A) shows, by way of example, a first map 240 that may originate from a first (former) acquisition period and is currently inactive. It is the map of an environment with a cruciform hallway and three rooms A, B and C at three of the four ends of the hallway. The three rooms have different floor plans in order to better explain the present invention.

The first map 240 includes the hallway and the rooms A and B since they have already been explored, for example. Room C, on the other hand, is not contained in the map 240 (and therefore shown dashed).

Representation (B) shows, by way of example, a second map 242 that applies to the same environment as the first map 240 but includes or depicts other portions thereof because the environment has not yet been explored as much. The second map 242 only includes the hallway since the latter has already been explored, for example. Rooms A, B and C, on the other hand, are not contained in the map 242 (and therefore shown dashed).

Representation (C) now shows a merge of the first map 240 and the second map 242, wherein the data contained in the first map 240 are integrated into the second map 242. It is still the second map, but after the merge; it is therefore denoted by 242′.

Such a merge may take place, for example, after the second map has been compared to the first map and a certain match has been found. For example, a match between the hallway of the second and the hallway of the first map can be found.

However, as can be seen in the example of representation (C), the hallway could be rotated by 90° in each case without changing the match. The rooms A, B, C are not (yet) present on the second map in order to include them in the checking of the match. As a result, an incorrect merge may result, and thus an erroneous map, as shown in representation (C). The two maps were merged rotated; the end of the hallway that leads (or would lead) to room B in the second map overlaps the end of the hallway in the first map that leads to room A. The end of the hallway that leads (or would lead) to room C in the second map overlaps the end of the hallway in the first map that leads to room B.

Representation (D) now again shows the second map after the merge, but in comparison to representation (C), the second map is updated even further, namely by further data sets or scans during further movement of the mobile device; it is therefore denoted by 242″. As can be seen, in the movement beyond the end of the hallway that leads to room C in the second (and current or active) map, room C or its boundaries will also be recognized. However, based on the data of the integrated first map, room B is there on the map, resulting in contradictions. There is an unexpected occurrence (“unexpected appearance”) in the environment.

Representation (E) again shows the second map after the merge, but in comparison to representation (C), the second map is updated even further, namely by further data sets or scans during further movement of the mobile device; it is therefore denoted by 242′″. As can be seen, during the movement beyond the end of the hallway that leads to room A in the second (and current or active) map, room A or its boundaries will also be recognized. Although there is no contradiction here (at any rate not at this point in time) to the data originating from the first map, a recheck of the match would however find that there would be a better match (“better hypothesis”) if the second map were rotated counterclockwise by 90°.

Representation (D) again shows the second map after the merge, but in comparison to representation (C), the second map is updated even further, namely by further data sets or scans during further movement of the mobile device; it is therefore denoted by 242″″. As can be seen, during the movement beyond the end of the hallway that leads to room B in the second (and current or active) map, room B or its boundaries will also be recognized.

However, based on the data of the integrated first map, room A is there on the map, resulting in contradictions. There is an unexpected occurrence (“unexpected appearance”) in the environment. In addition, a recheck of the match would find that there would be a better match (“better hypothesis”) if the second map were rotated counterclockwise by 90°.

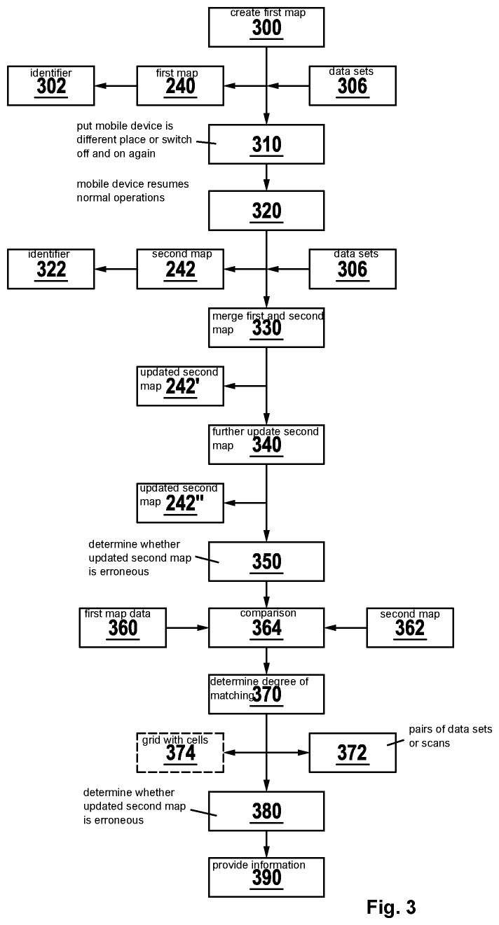

FIG. 3 schematically shows a sequence of a method according to the present invention in a preferred embodiment. In particular, reference is here also to be made to FIG. 2. First, in normal operation of the mobile device, a first map 240 of the environment may be created in a step 300. This takes place, for example, based on data sets 306, such as lidar scans or lidar point clouds, that are sensed. These data sets are assigned an identifier or ID 302 for a first acquisition period.

In step 310, the mobile device is now, for example, to be put in a different place or switched off and switched on again. It may also be that the lidar scans fail intermittently. In step 320, the mobile device resumes normal operation; in this case, the first map 240 is set to inactive and, for example, saved. A new, second map 242 is started. This again takes place, for example, based on data sets 306, such as lidar scans or lidar point clouds, that are sensed. These data sets are assigned an identifier or ID 322 for a second acquisition period.

After a certain period of time, in step 330, the first map 240 and the second map 242 are now merged by transferring at least a portion of the first map 240 into the second map 242. An updated second map 242′ (cf. representation (C) in FIG. 2) is obtained. With step 340, the second map is further updated with at least one further lidar scan or data set; an updated second map 242″ is obtained and provided.

In step 350, it is now determined whether the updated second map 242′″ is erroneous. For this purpose, a comparison 364 of the first map data 360 of the first map 240 from the first acquisition period to second map data 362 from the second acquisition period is performed. A degree of matching 370 between the second map data and the first map data is then determined. This can take place, for example, as explained in detail above. For example, pairs 372 of data sets or scans can be formed and examined for differences or matching.

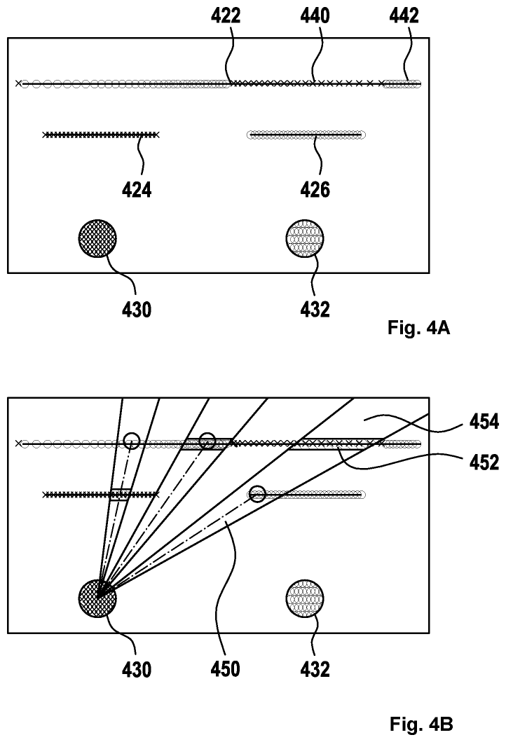

This is illustrated in more detail in FIG. 4. Representation (A) shows, in an environment with a long wall 422 and two short walls 424, 426, a position 430 (corresponding to a pose of the mobile device or sensor) with points 440 (data set from lidar scan, indicated with crosses) of a second acquisition period as well as a position 432 with points 442 (data set from lidar scan, indicated with circles) of a first acquisition period. The long wall 422 is seen from both positions; the short wall 424 is, for example, seen only from position 430; the short wall 426 is, for example, seen only from position 432.

Representation (B) shows exemplary beams for lidar scans, starting from position 430, as well as different class names that can be determined therefrom. For example, points in the area 450 are classified as “change” because they do not match, whereas points in the area 452 are classified as “agree” because they match. There is no information for the area 454.

In this example, points 442 of the second acquisition period or scan are classified using information resulting from the first acquisition period or scan.

Regions such as the area 452 result where the first scan has measured points. If a point of the second scan falls into this area, the measurements match, i.e., “agree” is present. Regions such as the area 450 result in areas prior to measurements of the first scan (i.e., locally between the position 430 and an associated point 440, for example). A measurement in the second scan in this area is classified as “change.” The object measured by the second scan was not present in the measurement of the first scan; otherwise, the first scan would not have been able to measure the more distant points because the view beam to the points 440 passes through the wall 426 (object). Regions such as the area 454 result in areas behind measurements of the first scan. Since these regions, like the area, have not been observed by the first scan, i.e., none of the view beams of the first scan passes through them, no statement regarding “change” or “agree” can be made on the basis of the first scan.

However, a map detail may also be determined by defining a grid 374 with cells, wherein the cells are checked as to whether nodes from both acquisition periods are located therein. In step 380, it is then determined whether or that the updated second map is erroneous if the degree of matching fulfills at least one specified criterion. In step 390, information in this respect can be provided. If it is not determined that the updated second map is erroneous, the method may start again with step 340 with a further updated second map. This may, for example. be repeated until a termination criterion is reached.

What is claimed is:

1. A method for recognizing an erroneous map of an environment, wherein the map has been obtained by merging a first map from a first acquisition period and a second map, which starts a second acquisition period, by transferring at least a portion of the first map into the second map, wherein each of the maps is respectively based on a SLAM graph and on data sets with information about the environment, which information has been obtained from a sensor of a mobile device, and wherein the map is used to navigate the mobile device in the environment, the method comprising:
providing an updated second map which has been obtained by merging the first map and the second map and which has been updated after the merge based on at least one new data set and/or one new node of the SLAM graph;
determining whether the updated second map is erroneous, including:
performing a comparison of first map data of the first map from the first acquisition period to second map data from the second acquisition period,
determining a degree of matching between the second map data and the first map data,
determining that the updated second map is erroneous when the degree of matching fulfills at least one specified criterion; and
providing information that the map is erroneous based on determining the updated second map is erroneous.

2. The method according to claim 1, wherein the first map data include one or more data sets, and wherein the second map data each include one or more data sets, wherein each data set of the first map data and the second map data includes a set of points, wherein performing the comparison includes:
forming one or more pairs of a data set of the first and of the second map data; and
determining, for each of the one or more pairs, for each of at least some points of the one or more data sets of the first or the second map data, whether or not the point matches a point of the respectively other data set of the pair;
wherein the degree of matching is determined based on a first number of points that match a point of the respectively other data set of the pair and a second number of points that do not match a point of the respectively other data set of the pair.

3. The method according to claim 2, wherein for the comparison, only those of the data sets of the first map data that overlap the data sets of the second map data at least by a given amount are used for the first map data.

4. The method according to claim 2, wherein a respectively new updated second map is repeatedly provided, which are respectively updated again in relation to a previous updated second map, and wherein the comparison is in each case performed again with the new updated second maps.

5. The method according to claim 1, wherein performing the comparison includes:
determining, based on the second map data, a map detail of the updated second map,
defining a regular grid with cells for the map detail, and
determining, for each of at least some of the cells of the grid, whether a second node of a SLAM graph from the second acquisition period is located in the respective cell, and whether a first node of a SLAM graph from the first acquisition period is located in the respective cell,
wherein the degree of matching is determined based on a first number of cells in which first and second nodes are located and a second number in which only a first node or only a second node is located.

6. The method according to claim 1, further comprising, when the updated second map is not determined as being erroneous:
providing a new updated second map, which is updated again in relation to a previous updated second map; and
determining whether the new updated second map is erroneous.

7. The method according to claim 1, wherein determining whether the updated second map is erroneous, includes:
determining a further degree of matching between the updated second map, to the extent that it is based on map data from the second acquisition period, and the first map,
comparing the further degree of matching with a corresponding degree of matching from before the merge, and
determining that the updated second map is erroneous when the further degree of matching fulfills at least one specified criterion.

8. The method according to claim 1, wherein the data sets include point clouds obtained from a sensor of the mobile device designed as a lidar.

9. The method according to claim 1, furthermore comprising: when it has been determined that the map is erroneous:
removing, at least partially, the portion transferred from the first map into the second map, including nodes and/or edges of the SLAM graph.

10. The method according to claim 1, furthermore comprising:
determining navigation information for the mobile device, based on the map.

11. A system for data processing, the system configured to recognize an erroneous map of an environment, wherein the map has been obtained by merging a first map from a first acquisition period and a second map, which starts a second acquisition period, by transferring at least a portion of the first map into the second map, wherein each of the maps is respectively based on a SLAM graph and on data sets with information about the environment, which information has been obtained from a sensor of a mobile device, and wherein the map is used to navigate the mobile device in the environment, the system configured to:
provide an updated second map which has been obtained by merging the first map and the second map and which has been updated after the merge based on at least one new data set and/or one new node of the SLAM graph;
determine whether the updated second map is erroneous, including:
performing a comparison of first map data of the first map from the first acquisition period to second map data from the second acquisition period,
determining a degree of matching between the second map data and the first map data,
determining that the updated second map is erroneous when the degree of matching fulfills at least one specified criterion; and
provide information that the map is erroneous based on determining the updated second map is erroneous.

12. A mobile device, comprising:
a system for data processing, the system configured to recognize an erroneous map of an environment, wherein the map has been obtained by merging a first map from a first acquisition period and a second map, which starts a second acquisition period, by transferring at least a portion of the first map into the second map, wherein each of the maps is respectively based on a SLAM graph and on data sets with information about the environment, which information has been obtained from a sensor of a mobile device, and wherein the map is used to navigate the mobile device in the environment, the system configured to:
provide an updated second map which has been obtained by merging the first map and the second map and which has been updated after the merge based on at least one new data set and/or one new node of the SLAM graph;
determine whether the updated second map is erroneous, including:
performing a comparison of first map data of the first map from the first acquisition period to second map data from the second acquisition period,
determining a degree of matching between the second map data and the first map data,
determining that the updated second map is erroneous when the degree of matching fulfills at least one specified criterion; and
provide information that the map is erroneous based on determining the updated second map is erroneous;
determine navigation information for the mobile device, based on the map; and
a control or regulating unit, and a drive unit configured to move the mobile device according to the navigation information.

13. The mobile device according to claim 12 wherein the mobile device is a vehicle moving in an at least partially automated manner, including: i) a passenger transport vehicle or a goods transport vehicle, and/or ii) a robot including a robotic vacuum cleaner and/or mopping robot and/or a ground or road cleaning device and/or robotic mower, and/or ii) a drone.

14. A non-transitory computer-readable storage medium on which is stored a computer program for recognizing an erroneous map of an environment, wherein the map has been obtained by merging a first map from a first acquisition period and a second map, which starts a second acquisition period, by transferring at least a portion of the first map into the second map, wherein each of the maps is respectively based on a SLAM graph and on data sets with information about the environment, which information has been obtained from a sensor of a mobile device, and wherein the map is used to navigate the mobile device in the environment, the computer program, when executed by a computer, causing the computer to perform the following steps:
providing an updated second map which has been obtained by merging the first map and the second map and which has been updated after the merge based on at least one new data set and/or one new node of the SLAM graph;
determining whether the updated second map is erroneous, including:
performing a comparison of first map data of the first map from the first acquisition period to second map data from the second acquisition period,
determining a degree of matching between the second map data and the first map data,
determining that the updated second map is erroneous when the degree of matching fulfills at least one specified criterion; and
providing information that the map is erroneous based on determining the updated second map is erroneous.
